(19) United States
(12) Patent Application Publication
(10) Pub. No.: US 2005/0155938 A1
(43) Pub. Date: Jul. 21, 2005

(54) Treatment of aircraft water systems using ozone

(76) Inventor: William A. Wilp, Ballwin, MO (US)

Correspondence Address: WILLIAM A. WILP, 103 FALMOUTH DR, BALLWIN, MO, 63011, US

(21) Appl. No.: 10/991,913

(22) Filed: Nov. 17, 2004

Related U.S. Application Data
(60) Provisional application No. 60/524,602, filed on Nov. 24, 2003.

(51) Int. Cl. C02F 1/78

(52) U.S. Cl. 210/760

(57) ABSTRACT

Electrical treatment for aircraft water systems using ozone

### BACKGROUND

1. Field of Invention

This invention relates to the use of proven ozone generation technology to address the potable water problems experienced in the airline industry.

2. Background of the Invention

The airline industry has long experienced the troublesome problem of persistent biological contamination and biofilm formation in the potable water and waste systems. This results in a health hazard to the passengers and crew. The elusive solution has resulted in continuing expensive and inadequate attempts to eliminate the problem by the use of chemical additives such as highly toxic and corrosive chlorine. In addition, the biofilms promote mineral deposit build up within the plumbing systems which, if left unaddressed, create maintenance and mechanical repair problems and further the retention of pathogens.

The existing preventative maintenance procedures vary from airline to airline but all involve a purging of the system with some chemical agent. This requires that the aircraft must to be taken out of service for a time period that represents a major operating expense.

Ozone has a demonstrated and outstanding record of superiority over chemical additives since its introduction as a disinfectant for water systems in 1906.

Ozone is an extremely unstable molecule consisting of three oxygen atoms that is create with the exposure of water to high electrical discharge. It has a half life of less than 10 minutes. Temperature is the controlling factor in the decay rate. This short life is utilized in the Pause Purge Cycle to disinfect the heretofore highly resistant plumbing systems.

### OBJECTS AND ADVANTAGES

Accordingly beside the aspects and advantages of the ozone generation system described in my above patent, several objects and advantages of the present invention are:
(a) to provide a powerful, short lived, biocide and virus deactivant.
(b) to provide oxidization for many undesirable organic contaminants.
(c) to provide flexibility of configurations for treatment application.
(d) to provide a reduction of scheduled down time.
(e) to provide a reduction in the problems created by mineral deposits.
(f) to provide flexibility in the placement of the components involved in the generation of ozone.
(g) to provide an effective solution at reduced maintenance costs

### DRAWING FIGURES—FIGS. 1 TO 5

FIG. 1 shows possible ozone injection position options within a water supply system.

FIG. 2 shows the preferred installation for biocide purge on demand using ground electrical power

FIG. 3 shows water treatment initiated by flow using either aircraft or ground power.

FIG. 4 shows the treatment of water as it is taken on board.

FIG. 5 shows water treatment in the reservoir.

### REFERENCE NUMERALS IN DRAWINGS

1 ozone injector placed at the inlet to reservoir

2 ozone injector placed at the bottom of reservoir

3 ozone injector placed at the outlet from reservoir

### SUMMARY

In accordance with the present invention, ozone generator technology modified to conform with FAA, EPA and FDA regulations as well as specific airline operational concerns, is added to the water supply system of the aircraft. The ozone generator can be installed as a complete unit or separated into its major components to facilitate installation within the constraints of the space available for a given aircraft model and configuration. The position of the ozone injection is dependent upon the maintenance procedures of the particular airline which in turn are established by the particular environment of their operation.

### DESCRIPTION—FIGS. 1 TO 5

FIG. 1 shows the possible ozone injection position options within an existing water supply system

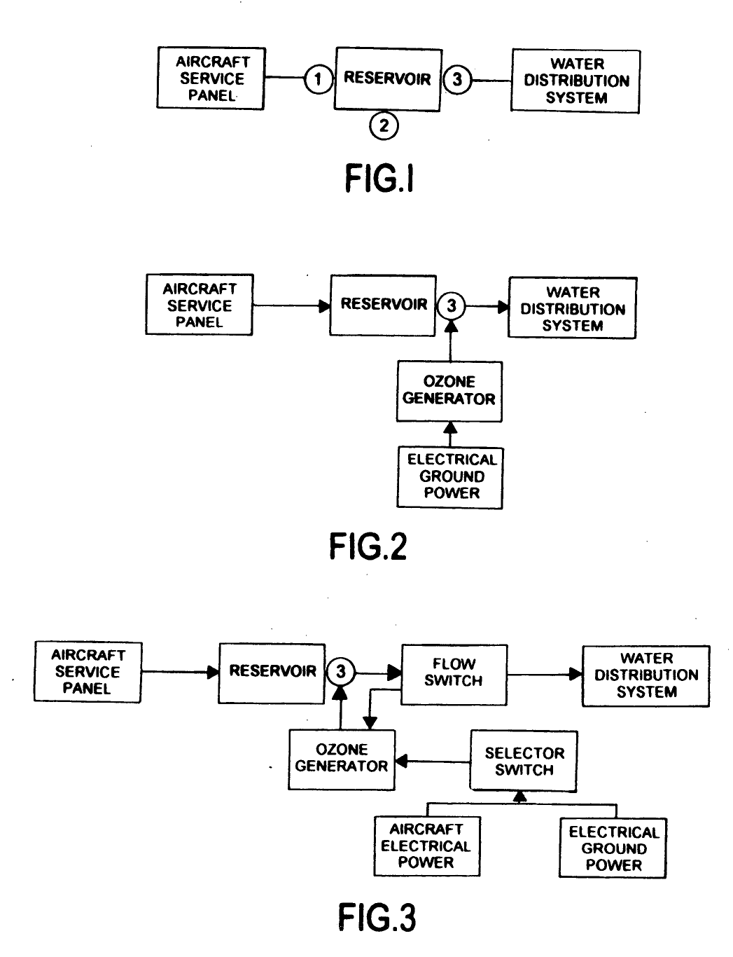

FIGS. 2 to 5 While there are a wide range of ozone generator designs, they all contain the same fundamental elements.
High Voltage power supply
Air compressor
Dialectical discharge gap
Venturi
Control circuits
Feedback sensors for:
   Temperature
   pH
   Ozone Concentration

FIG. 2 shows the installation commensurate with current maintenance practices for biocide purge on command using ground electrical power

FIG. 3 shows water treatment initiated by flow demand using either aircraft or ground power. The aircraft power source option is to accommodate those locations where ground power is unavailable.

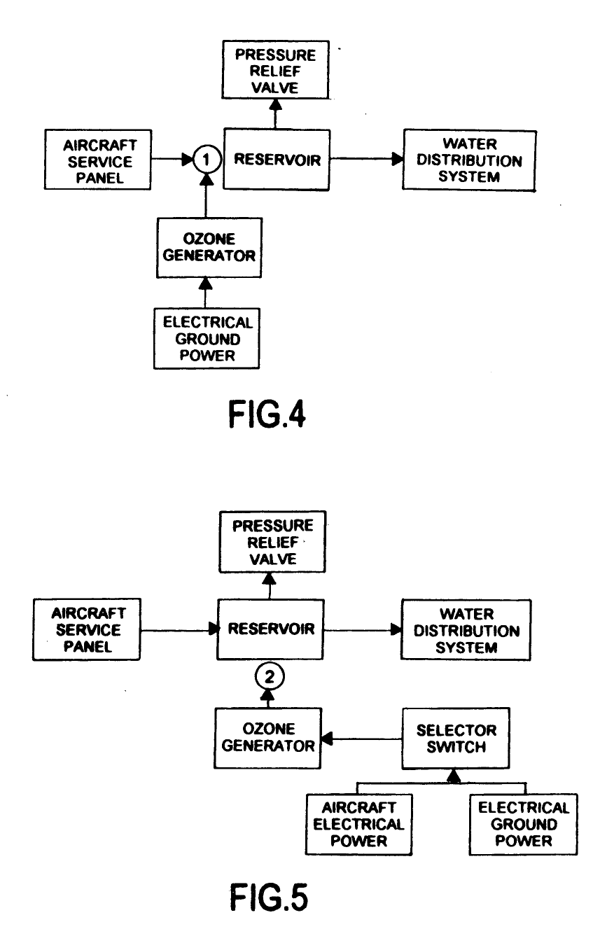

FIG. 4 shows the treatment of water as it is taken on board

FIG. 5 shows the treatment of water in the reservoir

Operations—FIGS. 1 to 5

FIG. 1 The ozone stream can be introduced into the water supply at different or multiple locations depending upon the problems imposed by the aircraft's operating environment.

FIGS. 2 to 5 The selection of the type of electrical power to operate the ozone generator is dependent on the users operating environment and procedures.

FIG. 2 This configuration provides a convenient biocide purge particularly during normal maintenance cycles or on an as needed basis without the introduction of additional chemical additives. This procedure results in a substantial reduction, if not the elimination, in aircraft down time to disinfect the water system. This procedure can be performed by the cabin crew by following a schedule of introducing and holding ozone treated water in the water distribution system for prescribed time period. This pause period allow the time required for disinfection action and the subsequent ozone decay. It is then flushed to eliminate the residue which contains nutrients that can facilitate future pathogen growth. This is the Pause Purge Cycle and represents the preferred and normal usage.

FIG. 3 This configuration provides for constant biocide capability initiated by flow demand.

FIG. 4 This configuration of ozone introduction placement allows water to be treated as it is added to the reservoir. It is directed at specific environments where the external water supply is of questionable quality.

FIG. 5 This placement allows for water treatment within the reservoir should there be some question of purity for any reason.

FIGS. 4 and 5 These two configurations have an added component that is not part of the production and application of ozone. This is the Pressure Relief Valve. Its function is to relieve the pressure created by ozone injection that may be beyond the capacity of the existing vent system.

Conclusions, Ramifications, and Scope

This invention will provide a highly effective and more efficient biocide at a reasonable cost that can be applied to any aircraft water system. The Pause Purge Cycle may be used to disinfect any Water Distribution System. A Water Distribution System is defined as the plumbing and valves necessary for the transport the water from its source to its discharge point.

Reference Cited

Ozone Treatment for Cooling Towers, Federal Technology Alert,

U.S. Department of Energy

1. Ozone water treatment in aircraft applications.

2. Any treatment of a Water Distribution System using the Pause Purge Cycle.
